(19) United States
(12) Patent Application Publication
(10) Pub. No.: US 2005/0275174 A1
(43) Pub. Date: Dec. 15, 2005

(54) Wheelbarrel with pivoting hopper

(75) Inventors: Joshua O. Mullen, Duncannon, PA (US); Michael J. Lupey JR., Waterfall, PA (US)

Correspondence Address: David C. Jenkins;Eckert Seamans Cherin & Mellott, LLC, 44th Floor, 600 Grant Street, Pittsburgh, PA, 15219, US

(73) Assignee: Ames True Temper, Inc., Camp Hill, PA (US)

(21) Appl. No.: 10/867,833

(22) Filed: Jun. 15, 2004

(51) Int. Cl. B62B 1/00

(52) U.S. Cl. 280/47.26

(57) ABSTRACT

A wheelbarrow that includes a frame assembly and a hopper assembly. The frame assembly has at least one wheel rotatably coupled thereto and a forward extension extending beyond the at least one wheel. The hopper assembly has a hopper. The hopper is pivotally coupled to the frame assembly at a first pivot point. The forward extension has a ground contact point structured to act as a second pivot point. The hopper is structured to be emptied by pivoting the hopper about either the first or the second pivot points. The first and second pivot points are stationary pivot points when the hopper is being emptied.

### BACKGROUND OF THE INVENTION

1. Field of the Invention

This invention relates to wheelbarrows and, more specifically, to a wheelbarrow having a pivoting hopper.

2. Background Information

Wheelbarrows are well known in the art. Typically, a wheelbarrow includes a hopper, a yoke, a wheel, and a brace. The yoke includes two elongated members typically joined by a nose guard at the forward most point. The elongated members may be shaped to be lower at the forward end and higher at the back end. The back end of the yoke members are used as handles. The hopper rests on, or in between, a medial portion of the yoke members. The wheel is disposed on an axle that extends between the yoke members adjacent to the front end of the yoke and behind the nose guard. Alternatively, the wheelbarrow may not have a nose guard and the wheel may extend beyond the yoke. A brace typically includes two leg members which extend downwardly from each yoke member adjacent to the back side of the hopper.

In this configuration, and when the wheelbarrow is not in motion, the wheelbarrow rests on the two leg members and the wheel. Friction between the ground and the leg members typically arrests the rolling movement of the wheel. To move the wheelbarrow, the user lifts on the handle portion of the yoke so that leg members are raised off the ground. The wheelbarrow may then be moved on the wheel. The hopper on the wheelbarrow may be used to transport various items, and is particularly adapted to hold granulated materials such as, but not limited to, sand, gravel and cement. While the hopper may be emptied by tilting the hopper to one side, users often wish to empty the hopper over the front edge. To empty the hopper forwardly, the user lifted the handles causing the yoke, and therefore the hopper, to pivot about the wheel. Continued lifting on the handles caused the nose guard to contact the ground. At that point, additional lifting on the handles cause the entire wheelbarrow to pivot about the nose guard, thereby further tilting the hopper.

There are several disadvantages to the traditional wheelbarrow. For example, with a single front wheel, the wheelbarrow is prone to tip laterally while in motion. Additionally, in order to empty the hopper forwardly, the user must stand behind the wheelbarrow. This position generally precludes the user from seeing where the contents of the hopper fall. Thus, for example, a user trying to pour concrete into a narrow form may initially miss the form. Also, when the hopper is very full, the material in the hopper may spill out before the nose guard has contacted the ground. In this situation, the wheelbarrow is very likely to roll on the wheel as there is no mechanism for stopping such a motion. Additionally, even when the nose guard is contacting the ground, the traditional wheelbarrow provides the user with a limited amount of control as to the speed of material emptying from the hopper.

The disadvantages of the traditional wheelbarrow have been addressed piecemeal. For example, to address the issue of tipping sideways during movement, wheelbarrows have been adapted to have two spaced wheels. To address the issue of controlling the rate of emptying the hopper, wheelbarrows have been adapted to have pivotal hoppers coupled to a frame. These pivoting hopper wheelbarrows have always had a forward wheel, or wheels. These wheelbarrows contemplated using the pivoting hopper as the only means of emptying the hopper. That is, if a user wished to tilt the hopper by lifting on the frame, a wheelbarrow with one or more forward wheels would tend to roll once the brace was lifted off the ground. This is a disadvantage as the hopper was typically not structured to tip to a fully vertical position and therefore was difficult to empty completely. Thus, the prior art pivoting hopper wheelbarrows were difficult to control as they did not include two stationary pivot points.

There is, therefore, a need for a wheelbarrow structured so that the user may utilize either of two stationary pivot points to empty the hopper.

There is a further need for a wheelbarrow structured with a pivotal hopper coupled to a frame and a frame having a ground contact point that engages the ground when the wheelbarrow is at rest.

### SUMMARY OF THE INVENTION

These needs, and others, are met by the present invention which discloses a wheelbarrow having a hopper pivotally coupled to a frame assembly. The frame assembly supports the hopper and includes two spaced wheels coupled to frame members. The frame assembly includes a handle member disposed behind the wheels and forward extensions which extend to the front of the wheels. The forward extensions act as a brace when the wheelbarrow is at rest. When a user lifts on the handle member, the wheelbarrow pivots about the lower, forward most point on the forward extensions. This action also lifts the wheels off the ground so that the wheelbarrow does not roll. Preferably, the hopper is pivotally coupled to the frame assembly at the front edge of the hopper. Thus, when a user wishes to empty the hopper, the user may pivot the hopper about either or both pivot points. When using the pivoting hopper only, the user is not lifting the entire wheelbarrow, the load the user lifts is smaller and the user generally has greater control. Additionally, the user may stand to the side of the hopper while lifting the hopper so that she may see where the contents of the hopper are falling.

### BRIEF DESCRIPTION OF THE DRAWINGS

A full understanding of the invention can be gained from the following description of the preferred embodiments when read in conjunction with the accompanying drawings in which:

FIG. 1 is a side view of the wheelbarrow of the present invention.

FIG. 2 is a side view of the wheelbarrow of FIG. 1 showing a hopper in a pivoted position.

FIG. 3 is an isometric view of the wheelbarrow in FIG. 2.

FIG. 4 is an exploded view of the wheelbarrow of the present invention.

### DESCRIPTION OF THE PREFERRED EMBODIMENTS

As used herein, directional terms, such as, but not limited to, “forward,” “right,” “left,” “upper” and “lower,” correspond to the orientation of the wheelbarrow from the perspective of a user standing at the handle member looking toward the hopper—that is, the normal position a user would occupy to move the wheelbarrow. Such directional terms are not limiting upon the claims.

As used herein, a wheelbarrow is considered “stationary” when a brace, or similar structure, is engaging the ground so that the wheel may not roll without overcoming the static friction between the brace and the ground.

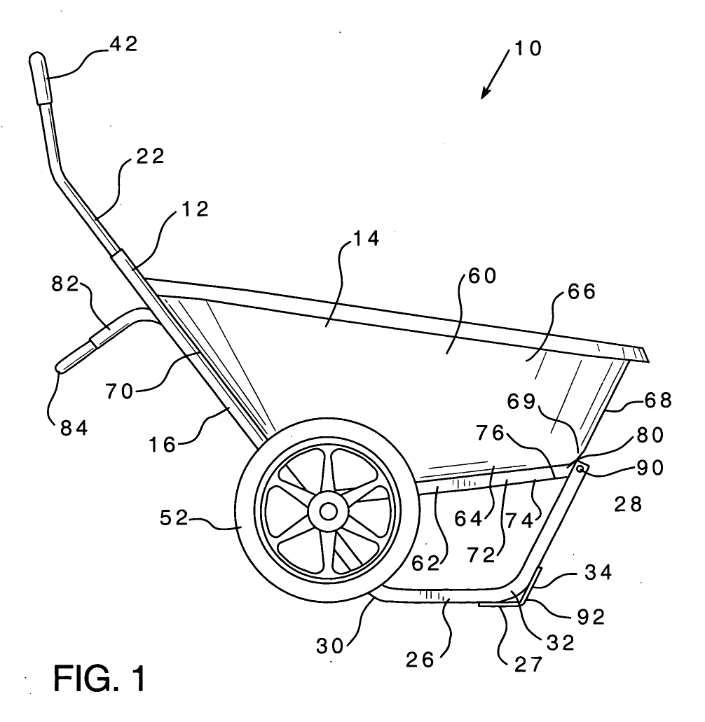

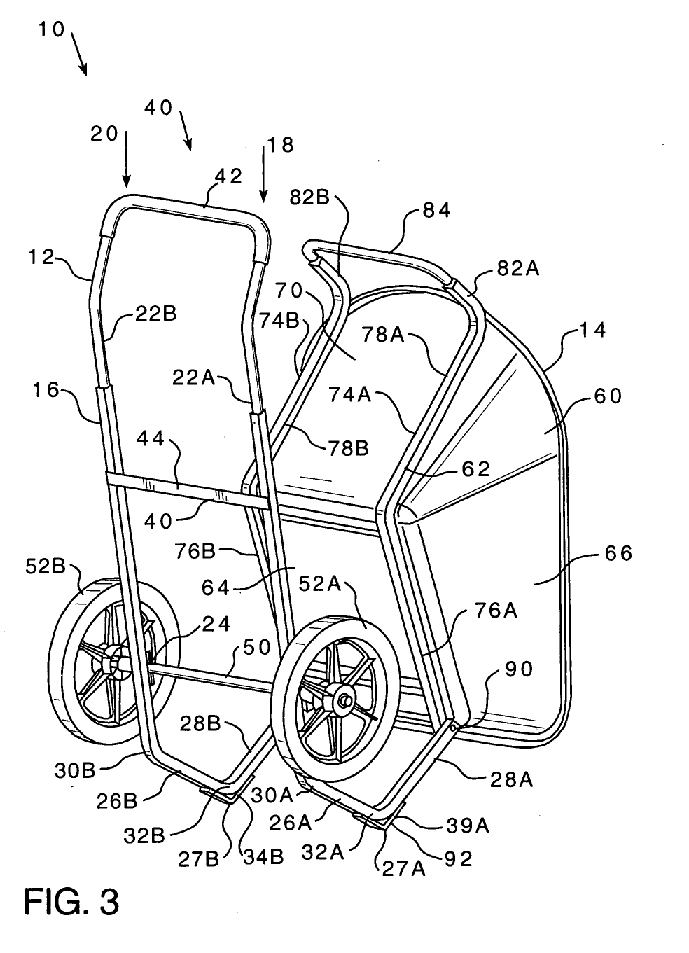

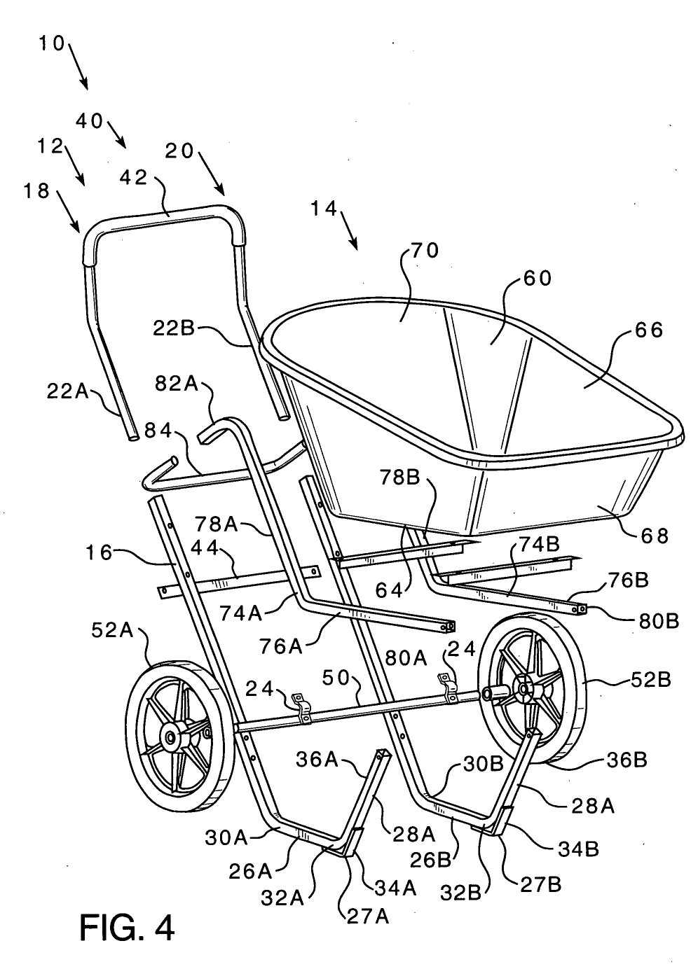

As shown in FIGS. 1-4, the present invention provides a wheelbarrow 10 having a frame assembly 12 and a hopper assembly 14. The frame assembly 12 includes a plurality of rigid frame members 16. The frame members 16 preferably form symmetrical right and left frames 18, 20, respectively (FIG. 3). Each frame 18, 20 includes an elongated handle portion 22, an axle mount 24, a forward extension 26, and a riser 28. The handle portion 22 and the forward extension 26 are joined at a first vertex 30. The forward extension 26 extends at an angle relative to the handle portion 22. The angle of the first vertex 30 is, preferably, less than about a 90 degree angle. The axle mount 24 is, preferably, disposed adjacent to the first vertex 30. The forward extension 26 and the riser 28 are joined at a second vertex 32. The riser 28 extends at an angle relative to the forward extension 26. The angle of the second vertex 32 is, preferably, less than about a 90 degree angle. The riser 28 is, preferably, shorter than the handle portion 22. The riser 28 includes a distal end portion 36 that is structured to be pivotally coupled to the hopper assembly 14. That is, the riser distal end portion 36 includes a structure such as, but not limited to, a pivot rod or an opening for a pivot rod (not shown). It is also possible, however, to have the riser 28 extend from a medial point (not shown) on the forward extension 26. Thus, the forward extension 26 could extend beyond the riser 28.

As described below, the hopper 60 may be emptied by pivoting the wheelbarrow 10 about the lowest, forward point on the frame assembly 12. The forward extension 26 has a ground contact point 27 at the lowest, forward point on the frame assembly 12. The ground contact point 27 also acts as a brace when the wheelbarrow 10 is at rest. Thus, in this configuration, when the wheelbarrow is at rest the ground contact point 27 of the brace is located in front of the wheel 52 (described below). When the wheelbarrow 10 is tipped, as described below, the tipping motion lifts the wheel 52 off the ground first as the wheelbarrow 10 pivots about the ground contact point 27. In the embodiment shown in the Figures, the second vertex 32 is the lowest, forward point on the frame assembly 12. Thus, as described below, the second vertex 32 is the ground contact point 27 that acts as a pivot point when emptying the hopper 60. Accordingly, the second vertex 32 may be protected by a shield member 34. The shield member 34 may have a non-slip lower surface.

As noted above, the frame assembly 12 preferably has a right and left frame 18, 20. Hereinafter, the various elements of the right frame 18 will be followed by the letter “A” and the various elements of the left frame 20 will be followed by the letter “B.” For example, the handle portion 22 on the right frame 18 is identified as the right frame handle portion 22A, while the handle portion 22 on the left frame 20 is identified as the left frame handle portion 22B. The right frame 18 and the left frame 20 are held in a spaced relation by a plurality of cross members 40 as well as the hopper assembly 14. The cross members 40 include a handle member 42 and a hopper assembly support 44. As described below, the hopper assembly 14 is pivotally couple to the risers 28A, 28B and thereby holds the risers 28A, 28B in a spaced relation. Additionally, the frame assembly 12 further includes an axle 50 and at least one wheel 52. In a preferred embodiment, and as shown in the Figures, there are two wheels 52. The axle 50 is rotatably coupled to the frames 18, 20 by the axle mounts 24A, 24B. The wheels 52 are coupled to opposite ends of the axle 50.

The hopper assembly 14 includes a hopper 60 and a hopper assembly frame assembly 62. The hopper 60 includes a generally flat base plate 64 having a depending, flared peripheral sidewall 66. The sidewall 66 may have shorter front side 68 and a taller back side 70. The hopper assembly frame assembly 62 includes a plurality of rigid members 72. The hopper assembly frame assembly rigid members 72 include two generally L-shaped members, a right L-shaped member 74A and a left L-shaped member 74B. As with the frames 18, 20 described above, similar elements of the hopper assembly frame assembly 62 shall be described with similar reference numbers having and “A” or “B” to designate the right and left sides, respectively. The L-shaped members 74A, 74B correspond to the shape of the hopper 60 and are structured to be coupled to the lower side and back side of the hopper 60. Each L-shaped member 74A, 74B has a lower, front leg 76A, 76B and an upper back leg 78A, 78B. Each lower, front leg 76A, 76B is structured to be coupled to the lower side of the hopper base plate 64. Each upper back leg 78A, 78B is structured to be coupled to the outer side of the hopper back side 70. Each lower, front leg 76A, 76B has a distal end portion 80A, 80B. Each upper back leg 78A, 78B may have a handle portion 82A, 82B. As shown in the Figures, the hopper handle portion 82A, 82B extends generally perpendicular to the hopper back side 70. It is noted, however, that the hopper handle portion 82A, 82B may extend in any direction including, but not limited to, extending parallel to the associated upper back leg 78A, 78B or extending in a generally forward direction. A hopper handle member 84 extends between the two hopper handle portions 82A, 82B. The L-shaped members 74A, 74B are coupled to the hopper 60 in a spaced relation.

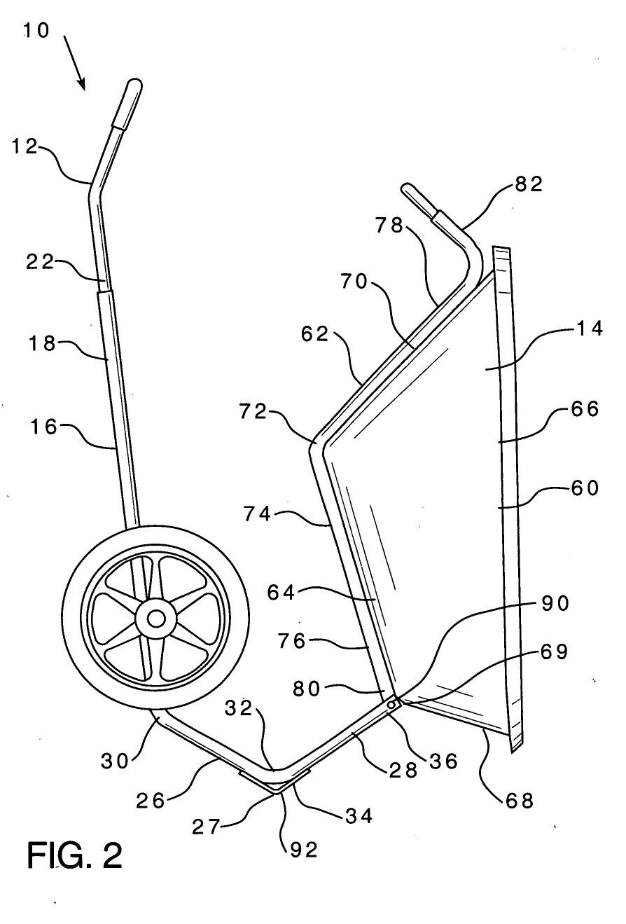

When assembled, the wheelbarrow 10 has the hopper assembly 14 pivotally coupled to the frame assembly 12 at a first pivot point 90. Preferably, the hopper lower, front leg distal end portions 80A, 80B are pivotally coupled to the riser distal end portions 36A, 36B. Thus, the front edge 69 of the hopper 60 is adjacent to the pivotal connection to the frame assembly 12. The hopper assembly 14 is structured to move between a first lower position, wherein the hopper base plate 64 is generally parallel to the forward extensions 26A, 26B, and a second, tilted position, wherein the hopper base plate 64 is angled relative to the forward extensions 26A, 26B. In the first position, the hopper assembly back side 70 rests on the hopper assembly support 44. The hopper assembly support 44 is positioned on the handle portions 22A, 22B at a location so that when the hopper assembly 14 is in the first position, the hopper base plate 64 is generally flat or tilted toward the hopper back side 70. As shown in FIGS. 1 and 2, when the hopper assembly 14 moves from the first position to the second position, the hopper assembly 14 pivots in a clockwise direction about the first pivot point 90.

In operation, the wheelbarrow 10 is operated as follows. Typically, the hopper 60 is filled with a material. At rest, the hopper assembly 14 is in the first position and the wheelbarrow 10 is supported by the wheels 52 and the shield members 34A, 34B. That is, the shield members 34A, 34B act as a brace supporting the front end of the hopper assembly 14. Additionally, the shield members 34A, 34B, which preferably include a slip resistant lower surface, arrest the rotation of the wheels 52. As such, when the shield members 34A, 34B are in contact with the ground, the shield members 34A, 34B act as a brake to inhibit the wheels 52 from rolling. To move the wheelbarrow 10, a user biases the handle member 42 downwardly causing the frame assembly 12 to pivot about the axle 50 and thereby lifting the shield members 34A, 34B off the ground. Once the shield members 34A, 34B are off the ground, the user may easily move the wheelbarrow 10 by pushing or pulling on the handle member 42 thereby causing the wheelbarrow 10 to roll on the wheels 52. Once the wheelbarrow 10 is in a desired position, the user discontinues the downward force on the handle member 42 and allows the shield members 34A, 34B to contact the ground.

To empty the hopper 60, the user may use either of the two pivot points 90, 92. That is, the user may, as with a traditional wheelbarrow, lift on the handle member 42. This action will cause the entire wheelbarrow 10, including the hopper 60, to pivot about the second pivot point 92. As noted above, the second pivot point 92 corresponds to the ground contact point 27 which, in this embodiment, is the second vertex 32. As the hopper 60 pivots, material in the hopper will spill out. Because the weight of the wheelbarrow 10 and the material rests on the shield members 34A, 34B at the second pivot point 92, the second pivot point 92 is not easily moved relative to the ground. That is, a large force would be required to overcome the static friction between the shield members 34A, 34B and the ground in order to cause the wheelbarrow 10 to move relative to the ground. Accordingly, the second pivot point 92 is a stationary pivot point.

Alternatively, the user may lift on the hopper handle member 84. This action causes the hopper assembly 14 to move from the first position to the second position. That is, the hopper assembly 14, including the hopper 60, is tilted forward. As the weight of the hopper assembly 14 and the material contained therein is being supported entirely by the risers 28A, 28B, there is a substantial downward force acting through the risers 28A, 28B on the shield members 34A, 34B at the second pivot point 92. As before, when there is a downward force acting on the shield members 34A, 34B, the second pivot point 92 is not likely to move relative to the ground. When the second pivot point 92, and therefore the frame assembly 12, is not easily moved relative to the ground, the first pivot point 90 is also not easily moved relative to the ground. Accordingly, the first pivot point 90 is a stationary pivot point. The user may also empty the hopper 60 utilizing both the first and the second pivot points 90, 92 consecutively or simultaneously.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A wheelbarrow comprising:
a frame assembly having at least one wheel rotatably coupled thereto and a forward extension extending beyond said at least one wheel;
a hopper assembly having a hopper;
said hopper pivotally coupled to said frame assembly at a first pivot point;
said forward extension having a ground contact point structured to act as a second pivot point;
said hopper structured to be emptied by pivoting said hopper about either the first or the second pivot points; and
wherein said first and second pivot points are stationary pivot points when said hopper is being emptied.

2. The wheelbarrow of claim 1, wherein said hopper has a front edge and said hopper is pivotally coupled to said frame assembly adjacent to said hopper front edge.

3. The wheelbarrow of claim 1, wherein
said frame assembly includes an elongated handle portion, a riser having a distal end portion, and an axle;
said wheel coupled to said axle;
said axle coupled to said handle portion;
said forward extension extending forward beyond said wheel;
said riser extending upwardly from said forward extension; and
said hopper front edge coupled to said riser distal end portion.

4. The wheelbarrow of claim 3, wherein
said hopper assembly further includes a hopper frame assembly;
said hopper coupled to said hopper frame assembly; and
said hopper frame assembly pivotally coupled to said riser.

5. The wheelbarrow of claim 4, wherein
said handle portion is coupled to forward extension at a first vertex;
said forward extension is coupled to said riser at a second vertex; and
said second vertex is said ground contact point.

6. The wheelbarrow of claim 5, wherein said frame assembly includes a shield member at said second vertex.

7. The wheelbarrow of claim 5, wherein
said hopper has a back side; and
said hopper frame assembly includes a handle member adjacent to said back side.

8. The wheelbarrow of claim 5, wherein
said at least one wheel includes a first and a second wheel; and
said first and second wheels disposed on opposite sides of said hopper.

9. The wheelbarrow of claim 8, wherein
said frame assembly includes a right side frame and a left side frame held in spaced relation;
each said right and left side frame having a handle portion, an axle mount, and a forward extension; and
said axle extending between said axle mounts.

10. The wheelbarrow of claim 7, wherein said frame assembly includes a handle member extending between the right side handle portion and the left side handle portion.

11. The wheelbarrow of claim 5, wherein
said frame assembly includes a right side frame and a left side frame held in spaced relation;
each said right and left side frame having a handle portion, an axle mount, and a forward extension; and
said axle extending between said axle mounts.

12. The wheelbarrow of claim 11, wherein said frame assembly includes a handle member extending between the right side handle portion and the left side handle portion.

13. The wheelbarrow of claim 5, wherein the angle of both the first and second vertex is less than about 90 degrees.
